(19) United States
(12) Patent Application Publication
(10) Pub. No.: US 2017/0180308 A1
(43) Pub. Date: Jun. 22, 2017

(54) ALLOCATION OF PORT ADDRESSES IN A LARGE-SCALE PROCESSING ENVIRONMENT

(71) Applicant: Bluedata Software, Inc., Mountain View, CA (US)

(72) Inventors: Swami Viswanathan, Morgan Hill, CA (US); Joel Baxter, San Carlos, CA (US)

(21) Appl. No.: 14/975,500

(22) Filed: Dec. 18, 2015

(51) Int. Cl. H04L 29/12; H04L 12/24; G06F 9/455; H04L 29/08

(52) U.S. Cl. CPC H04L 61/20; H04L 67/10; H04L 41/0803; G06F 9/45558; H04L 61/6072; G06F 2009/45595

(57) ABSTRACT

Systems, methods, and software described herein enhance addressing of services in a large-scale processing environment. In one implementation, a method of operating a control node of a large-scale processing environment includes receiving a request to configure a virtual cluster with data processing nodes on one or more hosts, and identifying services associated with the data processing nodes. The method further provides generating port addresses for each service in the data processing nodes, wherein services on a shared host of the one or more hosts are each provided a different port address. The method also includes allocating the port addresses to the services in the virtual cluster.

### TECHNICAL FIELD

Aspects of the disclosure are related to computing hardware and software technology, and in particular to allocating port addresses in a large-scale processing environment.

### TECHNICAL BACKGROUND

An increasing number of data-intensive distributed applications are being developed to serve various needs, such as processing very large data sets that generally cannot be handled by a single computer. Instead, clusters of computers are employed to distribute various tasks, such as organizing and accessing the data and performing related operations with respect to the data. Various applications and frameworks have been developed to interact with such large data sets, including Hive, HBase, Hadoop, Spark, among others.

At the same time, virtualization techniques have gained popularity and are now commonplace in data centers and other computing environments in which it is useful to increase the efficiency with which computing resources are used. In a virtualized environment, one or more virtual nodes are instantiated on an underlying physical computer and share the resources of the underlying computer. Accordingly, rather than implementing a single node per host computing system, multiple nodes may be deployed on a host to more efficiently use the processing resources of the computing system. These virtual nodes may include full operating system virtual machines, Linux containers, such as Docker containers, jails, or other similar types of virtual containment nodes. However, when virtual nodes are implemented within a cloud environment, such as in Amazon Elastic Compute Cloud (Amazon EC2), Microsoft Azure, Rackspace cloud services, or some other cloud environment, it may become difficult to address services within the virtual nodes of a processing cluster.

### OVERVIEW

The technology disclosed herein provides enhancements for addressing services in large-scale processing clusters. In one implementation, a method of operating a control node of a large-scale processing environment includes receiving a request to configure a virtual cluster with data processing nodes on one or more hosts, and identifying services associated with the data processing nodes. The method further provides generating port addresses for each service in the data processing nodes, wherein services on a shared host of the one or more hosts are each provided a different port address. The method also includes allocating the port addresses to the services in the virtual cluster.

This Overview is provided to introduce a selection of concepts in a simplified form that are further described below in the Technical Disclosure. It should be understood that this Overview is not intended to identify key features or essential features of the claimed subject matter, nor should it be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to allocate port addresses to services in large-scale processing nodes according to one implementation.

FIG. 2 illustrates a method of allocating port addresses to services in large-scale processing nodes according to one implementation.

FIG. 3 illustrates an operational scenario of allocating port addresses to services in large-scale processing nodes according to one implementation.

FIG. 4 illustrates a data structure for managing port addresses for services in a large-scale processing cluster according to one implementation.

FIG. 5 illustrates an operational scenario of providing port addresses to requesting console devices according to one implementation.

FIG. 6 illustrates a console view for addressing services in a large-scale processing environment according to one implementation.

FIG. 7 illustrates a control computing system to allocate port addresses to services in large-scale processing nodes according to one implementation.

### TECHNICAL DISCLOSURE

Large-scale processing environments (LSPEs) may employ a plurality of physical computing systems to provide efficient handling of job processes across a plurality of virtual data processing nodes. These virtual nodes may include full operating system virtual machines, Linux containers, Docker containers, jails, or other similar types of virtual containment nodes. In addition to the virtual processing nodes, data sources are made available to the virtual processing nodes that may be stored on the same physical computing systems or on separate physical computing systems and devices. These data sources may be stored using versions of the Hadoop distributed file system (HDFS), versions of the Google file system, versions of the Gluster file system (GlusterFS), or any other distributed file system version—including combinations thereof. Data sources may also be stored using object storage systems such as Swift.

To assign job processes, such as Apache Hadoop processes, Apache Spark processes, Disco processes, or other similar job processes to the host computing systems within a LSPE, a control node may be maintained that can distribute jobs within the environment for multiple tenants. A tenant may include, but is not limited to, a company using the LSPE, a division of a company using the LSPE, or some other defined user of the LSPE. In some implementations, LSPEs may comprise private serving computing systems, operating for a particular organization. However, in other implementations, in addition to or in place of the private serving computing systems, an organization may employ a cloud environment, such as Amazon Elastic Compute Cloud (Amazon EC2), Microsoft Azure, Rackspace cloud services, or some other cloud environment, which can provide on demand virtual computing resources to the organization. Within each of the virtual computing resources, or virtual machines, provided by the cloud environments, one or more virtual nodes may be instantiated that provide a platform for the large-scale data processing. These nodes may include containers or full operating system virtual machines that operate via the virtual computing resources. Accordingly, in addition to physical host machines, in some implementations, virtual host machines may be used to provide a platform for the large-scale processing nodes.

To assist in addressing the nodes within the environment, and in particular the services located thereon, port addressing may be used to directly identify and communicate information with the services of each of the nodes. These services may include Hadoop services, such as resource manager services, node manager services, and Hue services, Spark services, such as Spark master services, Spark worker services, and Zepplin notebook services, or any other service for large-scale processing clusters. By providing port addresses to each of the services of the environment, an administrator or user of a cluster may only require the address of the host system, and the port address of the individual service to receive and provide information to the corresponding service.

To provide the port addresses to the services within a cluster, the control node may be used to allocate and configure the services of a cluster with the port addresses. In one implementation, the control node is configured to identify a request for a cluster of one or more data processing nodes. In response to the request, the control node identifies services within the required processing nodes for the cluster, and allocates port addresses to each of the services. In allocating the port addresses to each of the services, the control node ensures that no duplicate ports are provided to two services on the same host. For example, if a host included three containers, with nine services executing thereon, then the nine services would each be provided with a different port address. Once the ports are determined for the services of the cluster, the ports are then configured in the cluster. By configuring the hosts, real or virtual, with the port configuration, an administrator or user may address the services using the internet protocol (IP) address of the host and the corresponding port number associated with the desired service.

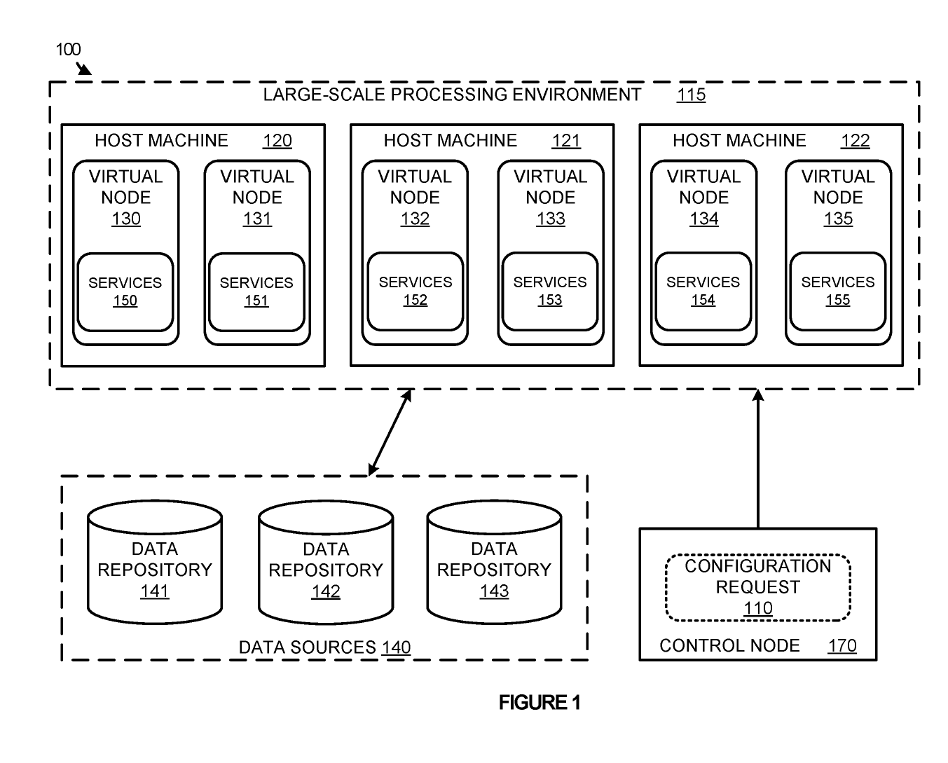

To further demonstrate the allocation of port addresses in a computing environment, FIG. 1 is provided. FIG. 1 illustrates a computing environment 100 to allocate port addresses to services in large-scale processing nodes according to one implementation. Computing environment 100 includes large-scale processing environment (LSPE) 115, data sources 140, and control node 170. LSPE 115 further includes host machines 120-122, which provide a platform for virtual nodes 130-135. Data sources 140 comprises data repositories 141-143 that are representative of databases stored using versions of the HDFS, versions of the Google file system, versions of the GlusterFS, or any other distributed file system version—including combinations thereof. Data repositories 141-143 may also store data using object based storage formats, such as Swift.

As illustrated in FIG. 1, control node 170 may be communicatively coupled to LSPE 115 permitting control node 170 to configure large-scale processing clusters, as they are required. These clusters may include Apache Hadoop clusters, Apache Spark clusters, or any other similar large-scale processing cluster. Here, configuration request 110 is received to generate a new, or modify an existing, virtual cluster within LSPE 115. In response to the request, control 170 identifies the required nodes to provide the operations desired, and configures the corresponding nodes within LSPE 115.

In the present implementation, virtual nodes 130-135 are provided for the large-scale processing operations and execute via host machines 120-122. Host machines 120-122, which may comprise physical or virtual machines in various implementations, provide a platform for the nodes to execute in a segregated environment while more efficiently using the resources of the physical computing system. Virtual nodes 130-135 may comprise full operating system virtual machines, Linux containers, Docker containers, jails, or other similar types of virtual containment nodes. Within each of containers 130-135 are services 150-155, which provide the large-scale processing operations such as MapReduce or other similar operations.

When a cluster modification request is received by control node 170, such as configuration request 110, control node 170 identifies the required nodes to support the modification and initiates the virtual nodes within the environment. To initiate the virtual nodes for the cluster, control node 170 may allocate preexisting nodes to the cluster, or may generate new nodes based on the received request. Once the nodes are identified, control node further identifies the various services associated with the nodes and allocates port addresses to each of the services, permitting an administrator or user to access the services.

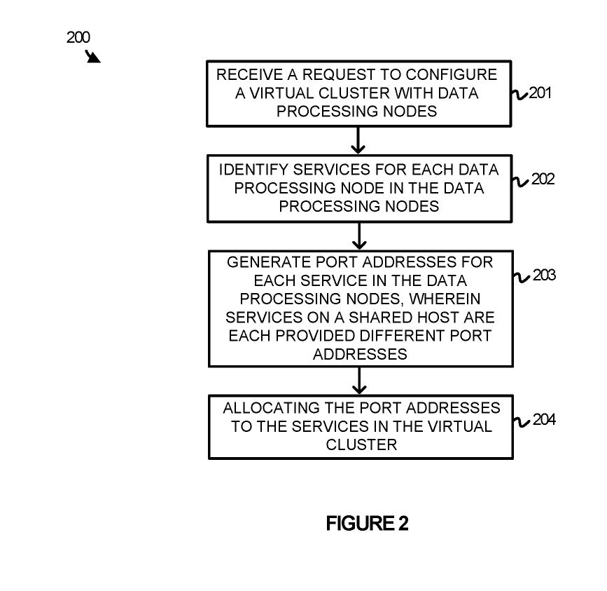

Referring now to FIG. 2 to further demonstrate the allocation of port addresses in a LSPE. FIG. 2 illustrates a method 200 of allocating port addresses to services in large-scale processing nodes according to one implementation. References to the operations of method 200 are indicated parenthetically in the paragraphs that follow with reference to elements of computing environment 100 from FIG. 1.

As described in FIG. 1, control node 170 is provided that is used to configure and allocate virtual processing clusters based on requests. These requests may be generated by an administrator of an organization, a member of an organization, or any other similar user with data processing requirements. The request may be generated locally at control node 170, may be generated by a console device communicatively coupled to control node 170, or by any other similar means. As a request is generated, control node 170 receives the request to configure a virtual cluster with data processing nodes on one or more hosts (201). These hosts may comprise physical computing devices in some examples, but may also comprise virtual machines capable of providing a platform for the virtual nodes.

Once the request is received, control node 170 identifies services for each data processing node in the data processing nodes for the cluster (202). In many cluster implementations, processing nodes include multiple services that provide the large-scale processing operations. For example, Hadoop nodes may include resource manager services, node manager services, and Hue services, Spark nodes may include resources such as Spark master services, Spark worker services, and Zepplin notebook services, and other large-scale processing frameworks may include any number of other services for their large-scale processing nodes. After the services have been identified, control node 170 generates port addresses for each service in the data processing nodes, wherein services shared on a host are each provided different port addresses (203). Referring to the example of FIG. 1, if a cluster were generated on host machines 120-121, services 150-151 could not share port addresses, and services 152-153 could not share port addresses. This permits each individual service to be addressed on the host machines using the IP address of the host machine and the port address for the desired service.

After generating the port addresses for the services of the virtual cluster, control node 170 allocates the port addresses to the services in the virtual cluster (204). To allocate the port addresses, control node 170 may configure and initiate the required virtual nodes for the cluster. This configuration may include allocating idle virtual nodes to the cluster, initiating new virtual nodes for the cluster, or any other similar means of providing nodes to the cluster. Further, control node 170 may configure the hosts for the cluster with the appropriate associations between the services and the ports. Accordingly, when a user desires to interface with a particular service within the cluster, the user may direct communications toward the IP address for the appropriate host and the port number of the desired service. Once the communication is received by the host, the host may use the port number to forward the interactions with the associated service.

Returning to the elements of FIG. 1, large-scale processing environment 115, data sources 140, and control node 170 may reside on serving computing systems, desktop computing systems, laptop computing systems, or any other similar computing systems, including combinations thereof. These computing systems may include storage systems, processing systems, communication interfaces, memory systems, or any other similar system.

To communicate between the computing systems in computing environment 100, metal, glass, optical, air, space, or some other material may be used as the transport media. The computing systems may also use various communication protocols, such as Time Division Multiplex (TDM), asynchronous transfer mode (ATM), Internet Protocol (IP), Ethernet, synchronous optical networking (SONET), hybrid fiber-coax (HFC), Universal Serial Bus (USB), circuit-switched, communication signaling, wireless communications, or some other communication format, including combinations, improvements, or variations thereof. The communication links between the computing systems can each be a direct link or can include intermediate networks, systems, or devices, and can include a logical network link transported over multiple physical links.

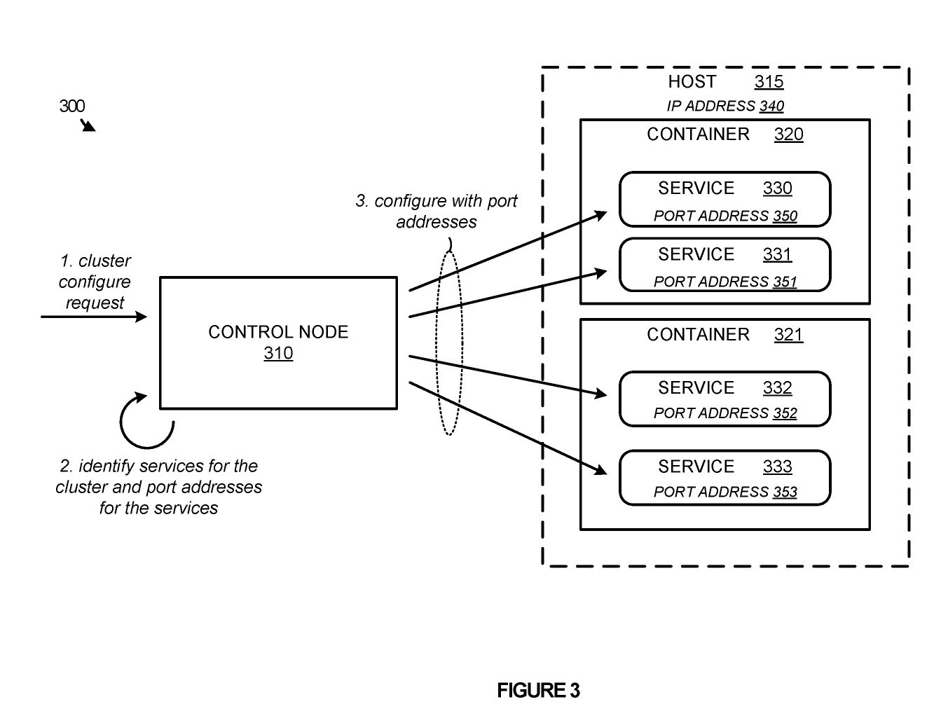

Turning to FIG. 3, FIG. 3 illustrates an operational scenario 300 of allocating port addresses to services in large-scale processing nodes according to one implementation. Operational scenario 300 includes control node 310, and host 315. Host 315 is representative of a physical computing system or virtual computing system capable of supporting containers 320-321. Containers 320-321 are representative of virtual data processing nodes for a LSPE, and may comprise Linux containers, Docker containers, or some other similar virtual segregation mechanism.

As illustrated, control node 310 receives a cluster request from a user associated with a LSPE. This user might be an administrator of the LSPE, an employee of an organization associated with the LSPE, or any other similar user of the LSPE. The request may comprise a request to generate a new processing cluster or may comprise a request to modify an existing cluster. In response to the request, control node 310 identifies the nodes that are required to support the request, and further identifies services associated with each of the nodes. In many implementations, nodes within a LSPE may include multiple services, which provide various operations for the large-scale data processing. These operations may include, but are not limited to, job tracking, data retrieval, and data processing, each of which may be accessible by a user associated with the cluster.

To make the services within the cluster accessible, control node 310 further identifies port addresses for each of the services associated with the nodes for the cluster configuration request. These port addresses permit each of the services to be addressed within the environment without providing a unique IP address to the individual services. Accordingly, when it is desirable to communicate with a particular service, the IP address for host 315 may be provided along with a corresponding port of the desired service. Based on the port number, host 315 may direct the communication to the appropriate service.

Once the port addresses are identified for the services, control node 310 configures or allocates the ports within the LSPE. In the present implementation, to support the original cluster request, containers 320-321 are initiated and configured to provide the desired operations. These containers include services 330-333, which provide the desired large-scale processing operations for the environment. As part of the configuration, each of the services in containers 320-321 are provided with port addresses 350-353, which allows a user to individually communicate with the services using a single IP address. In particular, if a user were required to communicate with service 331, the user would provide IP address 340 for host 315, and further provide port address 351 for service 331. The operating system or some other process on host 315 may then direct the communications of the user to service 331 based on the provided port address.

In some implementations, to permit users to communicate with the services of the generated cluster, control node 310 may maintain information about which services are allocated which port address. Accordingly, when a user requires access to one of the services, the user may request the port information maintained by the control node to identify the required port address. Once the information is obtained, the user may manually, or via a hyperlink supplied by control node 310, communicate with the desired service.

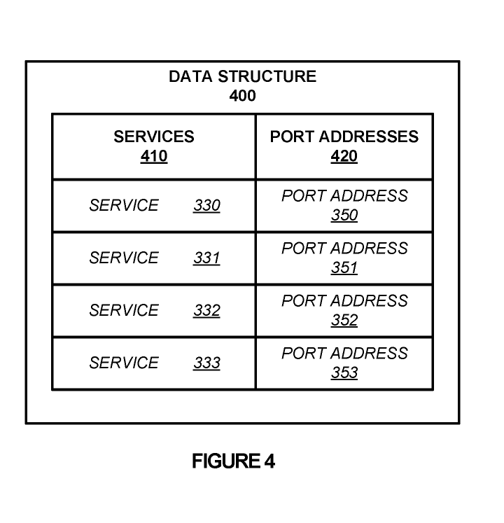

Referring to FIG. 4, FIG. 4 illustrates a data structure 400 for managing port addresses for services in a large-scale processing cluster according to one implementation. Data structure 400 is an example of a data structure that may be used to maintain port addressing information for a cluster in a LSPE. Data structure 400 includes service 410 and port addresses 420, which correspond to the services and port addresses from operational scenario 300 in FIG. 3. While illustrated in a table in the present example, it should be understood that any other data structure may be used to manage the addressing information for services 330 including, but not limited to, arrays, linked lists, trees, or any other data structure.

As described in FIG. 3, control node 310 may generate port addresses for services of a large-scale data processing cluster, permitting the individual services of the cluster to be accessible via the IP addresses of the host computing system. In addition to configuring the ports in the host systems, control node 310 may also manage a data structure to associate the services to the corresponding port address.

Once the data structure is created, users of the cluster may query control node 310 to identify the port numbers associated with the services of the cluster. In some implementations, the query by the end user may return a list of all of the corresponding services and port numbers of the cluster. However, it should be understood that any subset of the services and port numbers may be provided to the requesting user. For example, if the user were to request all of the services executing on a particular host, then only the services associated with the particular host will be provided to the user.

Although illustrated in the present example with two columns, it should be understood that the services may be associated with other information within data structure 400. For instance, in addition to providing the port address information for each of services 330-333, IP address information may also be provided indicating the host for the particular service. Accordingly, in addition to providing the user with port addresses 350-353, the user may also be provided with IP address 340 for the host system.

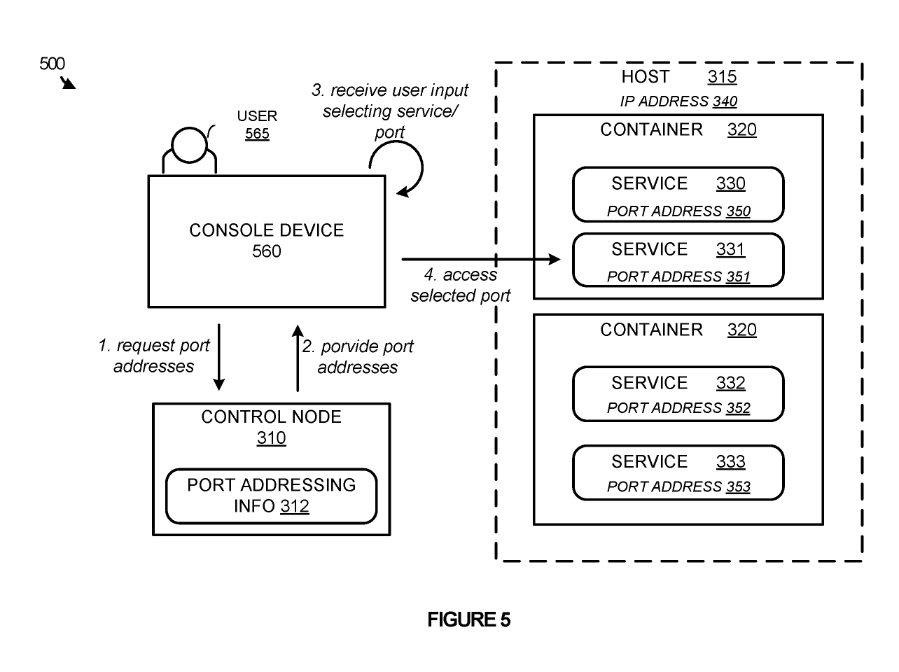

FIG. 5 illustrates an operational scenario 500 of providing port addresses to requesting console devices according to one implementation. Operational scenario 500 includes the systems and elements from operational scenario 300 of FIG. 3, and further includes console device 560 and user 565. Console device 560 may comprise a desktop computer, laptop computer, smart telephone, tablet, or any other similar type of user device.

As described in FIG. 4, while configuring a virtual cluster in response to a user request, control node 310 may further manage port addressing information using one or more data structures. This port addressing information assists users in directly addressing the various services within a large-scale processing cluster. Here, console device 560 is representative of a console computing system for user 565 associated with a processing cluster. During the operation of the cluster, user 565 may generate a request for port addresses associated with the cluster. This request may include a request for all of the port addresses, or a request for any portion of the port addresses. For example, user 565 may request port addresses for all services of a particular type, such as all slave worker services.

In response to the request, control node 310 identifies the appropriate port addresses for the request from port addressing info 312, and provides the port addresses to console device 560. In some implementations, to provide the port addresses, control node 310 may be configured to verify user 565. This verification may include username information for user 565, password information for user 565, or any other similar information to verify the user's access to a particular cluster. Once the port addresses are provided to console device 560, console device 560 may include a display permitting the user to make selections and access particular services within a cluster. In operational scenario 500, user 565 provides user input indicating the selection of service 331 or the selection of the particular port associated with service 331. In response to the selection, console device 560 may access the selected port, which may include receiving information for the service from host 315, providing information to the service on host 315, or any other similar operation.

In some implementations, to select the particular service, user 565 may manually enter the IP address and port number associated with the particular service. This manual entry may be made into an internet browser or any other similar application capable of accessing a service using IP address and port information. In other implementations, rather than manually entering the IP address and port information for the particular service, console device 560 may be provided with hyperlinks, buttons, or other similar user interface objects that, when selected by user 565, direct console device 560 to communicate with the required port.

Although illustrated in the examples of FIG. 3-5 using a single host system for the containers and services, it should be understood that any number of hosts may be used to provide the desired operations of the cluster. These hosts may be provided with any number of services and port addresses, permitting a user of the cluster to individually communicate with the services provided thereon. Further, because services may be located on different host systems with different IP addresses, services on separate hosts may be provided with the same port address.

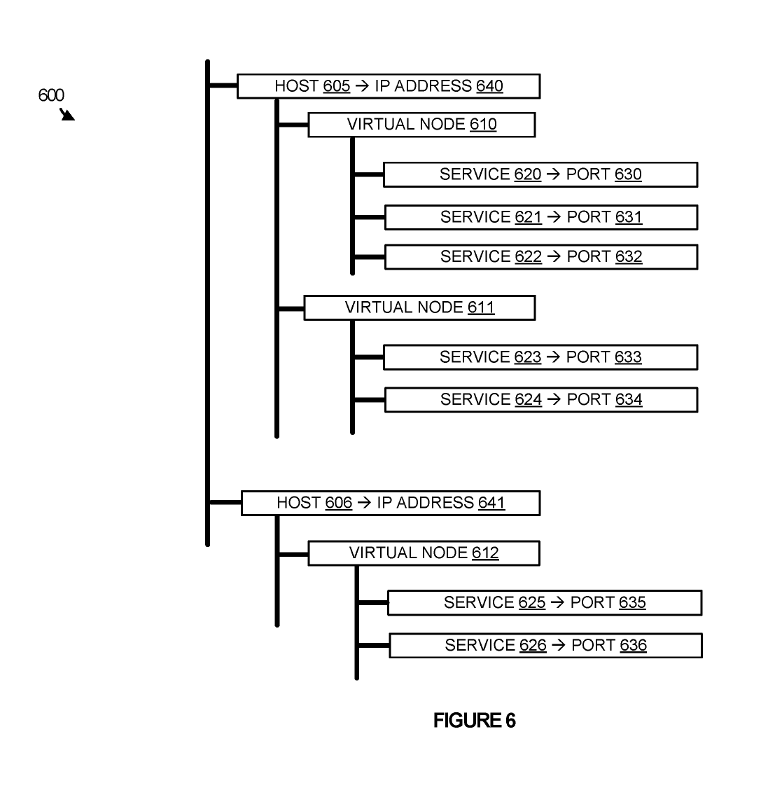

FIG. 6 illustrates a console view 600 for addressing services in a large-scale processing environment according to one implementation. Console view 600 is representative of a console view that may be presented to an administrator, employee, or any other similar user associated with a processing cluster. Console view 600 includes hosts 605-606, virtual nodes 610-612, and services 620-626. Hosts 605 are associated with IP addresses 640-641, and are representative of physical or virtual machines capable of supporting virtual nodes and large-scale data processing. Services 620-626 are representative of services that execute within large-scale processing node to provide the desired operations of the cluster. Console view 600 may be generated by the control node and may be displayed locally or provided to a console device using HTML or some other transmission format. In other implementations, a console device may generate console view 600 based on the information provided by the control node.

In operation, users of a LSPE generate clusters to perform desired tasks using Apache Hadoop, Apache Spark, or some other similar large-scale processing framework. As the required nodes are generated across host machines within the environment, the control node further manages the addressing information, permitting the users of the cluster to gather and provide information to services within the cluster. In particular, the control node configures the host machines with port addressing for the large-scale processing services located thereon, and manages one or more data structures that store the addressing information for these services.

Once the data structures are generated for the particular cluster, a user may inquire the control node to determine addressing information for the services of the cluster. In response to the inquiry, the control node identifies the relevant addresses and provides the addresses to the requesting user. In some implementations, the user may remotely request the addressing information at desktop, laptop, tablet, or some other similar user computing system. Accordingly, the addressing information must be transferred and provided to the user, permitting the user to identify the desired information. This transferring of the information may include generating a display at the control node, which can be displayed by the console device, or may include transferring the data associated with the addressing scheme, and permitting software on the console device to generate the display.

Here, console view 600 is representative of a console display that may be provided to a user of processing cluster. This view provides a hierarchical view of the various services of the cluster, permitting the user to identify and communicate with desired services across multiple hosts. In some implementations, the display IP address 640-641 and ports 630-636 may be used by the user to manually input into a web browser or some other application the address for the desired service. For example, the user may provide IP address 640 and port 631 to access service 621. In other implementations, rather than directly inputting the address of the desired service, console view 600 may include hyperlinks, buttons, or other similar user interface objects that permit a user to select the desired service and access the service in the appropriate application.

Although illustrated in the present example as a hierarchical view of a processing cluster, it should be understood that the services of a cluster may be displayed in a variety of different configurations. These configurations may include, but are not limited to, a table, a list, or some other visual representation of the processing cluster. Further, in providing the addressing information to the user, information may also be provided for a particular subset of the services of the cluster. For example, a user may request information for services executing a particular host. Consequently, rather than providing addressing information for the entire cluster, the control node may provide addressing information for the subset services located on the host machine.

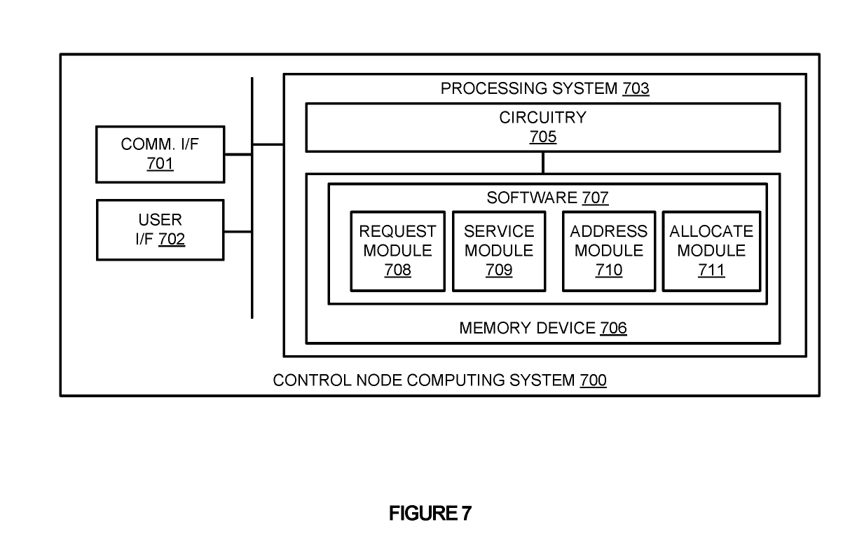

FIG. 7 illustrates a control node computing system 700 to allocate port addresses to services in large-scale processing nodes according to one implementation. Control node computing system 700 is representative of any computing system or systems with which the various operational architectures, processes, scenarios, and sequences disclosed herein for a LSPE control node may be implemented. Control node computing system 700 is an example of control nodes 170 and 310, although other examples may exist. Control node computing system 700 comprises communication interface 701, user interface 702, and processing system 703. Processing system 703 is linked to communication interface 701 and user interface 702. Processing system 703 includes processing circuitry 705 and memory device 706 that stores operating software 707. Administration computing system 700 may include other well-known components such as a battery and enclosure that are not shown for clarity. Computing system 700 may be a personal computer, server, or some other computing apparatus.

Communication interface 701 comprises components that communicate over communication links, such as network cards, ports, radio frequency (RF) transceivers, processing circuitry and software, or some other communication devices. Communication interface 701 may be configured to communicate over metallic, wireless, or optical links. Communication interface 701 may be configured to use Time Division Multiplex (TDM), Internet Protocol (IP), Ethernet, optical networking, wireless protocols, communication signaling, or some other communication format—including combinations thereof. In some implementations, communication interface 701 may be configured to communicate with host machines that provide a platform for the virtual processing nodes of the LSPE. These host machines may comprise physical computing systems, in some implementations, and may comprise virtual machines in other implementations. Further, communication interface 701 may be configured to communicate with console devices that allow a user to monitor and configure clusters within the LSPE.

User interface 702 comprises components that interact with a user to receive user inputs and to present media and/or information. User interface 702 may include a speaker, microphone, buttons, lights, display screen, touch screen, touch pad, scroll wheel, communication port, or some other user input/output apparatus—including combinations thereof. User interface 702 may be omitted in some examples.

Processing circuitry 705 comprises microprocessor and other circuitry that retrieves and executes operating software 707 from memory device 706. Memory device 706 comprises a non-transitory storage medium, such as a disk drive, flash drive, data storage circuitry, or some other memory apparatus. Processing circuitry 705 is typically mounted on a circuit board that may also hold memory device 706 and portions of communication interface 701 and user interface 702. Operating software 707 comprises computer programs, firmware, or some other form of machine-readable processing instructions. Operating software 707 includes request module 708, service module 709, address module 710, and allocate module 711, although any number of software modules may provide the same operation. Operating software 707 may further include an operating system, utilities, drivers, network interfaces, applications, or some other type of software. When executed by processing circuitry 705, operating software 707 directs processing system 703 to operate control node computing system 700 as described herein.

In particular, request module 708 directs processing system 703 to receive a request from a user of a LSPE to configure a virtual cluster processing nodes in the LSPE. This configuration request may comprise a request to generate a new cluster for large-scale data processing operations or may comprise a request to modify an existing cluster within the LSPE. In response to the request, service module 709 directs processing system 703 to identify services associated with the nodes to support the configuration request. These services may include Hadoop services, such as resource manager services, node manager services, and Hue services, Spark services, such as Spark master services, Spark worker services, and Zepplin notebook services, or any other service for large-scale processing clusters. Once the services are identified, address module 710 directs processing system 703 to port addresses for each service in the data processing nodes, wherein services on a shared host are each provided different port addresses. As described herein, a LSPE may employ physical hosts and/or virtual hosts to support the operation of processing clusters. Rather than providing the processing nodes with IP addresses, port addresses are provided to the individual services, permitting access to the services using the IP address allocated to the host and the port address allocated to the individual service.

After the port addresses are determined for the services, allocate module 711 directs processing system 703 to allocate the port addresses within the LSPE. In some implementations, the allocate operation may include configuring an operating system or some other process on the host to direct incoming communications to the appropriate service of the processing nodes. Accordingly, if a host provided a platform for one-hundred services, the operating system may identify the appropriate service for a communication based on the included port address.

In addition to configuring a cluster with the addressing information, control node computing system 700 may also maintain one or more data structures that manage the various services and port addressing information for the nodes. By maintaining the information, a user may, at a console device, request addressing information for a subset of the services in the cluster, and be provided with the required addressing information. Once the addressing information is provided, the information may be displayed to the user, permitting the user to access, monitor, make changes to the services of the cluster. In some implementations, the port addressing information may be displayed to the user requiring the user to manually input the address of the desired service into a web browser or other addressing application. In other implementations, hyperlinks, buttons, or other similar user interface objects may be provided. These objects allow the user to select a particular service, and be directed toward the address associated with the service.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a control node of a large-scale data processing environment, the method comprising:
receiving a request to configure a virtual cluster with data processing nodes on one or more hosts;
identifying services associated with the data processing nodes;
generating port addresses for each service in the data processing nodes, wherein services on a shared host of the one or more hosts are each provided a different port address; and
allocating the port addresses to the services in the virtual cluster.

2. The method of claim 1 wherein the virtual cluster comprises one of an Apache Hadoop cluster or an Apache Spark cluster.

3. The method of claim 1 further comprising:
receiving an address request for the virtual cluster from a console device;
identifying at least a portion of the port addresses associated with the virtual cluster based on the address request; and
transferring at least the portion of the port addresses associated with the virtual cluster to the console device.

4. The method of claim 3 further comprising:
identifying internet protocol (IP) addresses associated with the one or more hosts; and
transferring the IP addresses to the console device.

5. The method of claim 3 wherein transferring at least the portion of the port addresses associated with the virtual cluster to the console device comprises:
generating a display of at least the portion of the port addresses associated with the virtual cluster; and
transferring the display to the console device.

6. The method of claim 1 wherein the virtual nodes comprise Linux containers or Docker containers.

7. The method of claim 1 wherein the one or more hosts comprise one or more virtual machines.

8. The method of claim 1 wherein the one or more hosts comprise one or more physical computing systems.

9. The method of claim 1 wherein allocating the port addresses to the services in the virtual cluster comprises configuring operating systems on the one or more hosts with the port addresses for the services.

10. An apparatus to manage service addressing in a large-scale data processing environment, the apparatus comprising:
one or more non-transitory computer readable media;
processing instructions stored on the one or more non-transitory computer readable media that, when executed by a processing system, direct the processing system to:
receive a request to configure a virtual cluster with data processing nodes on one or more hosts;
identify services associated with the data processing nodes;
generate port addresses for each service in the data processing nodes, wherein services on a shared host of the one or more hosts are each provided a different port address; and
allocate the port addresses to the services in the virtual cluster.

11. The apparatus of claim 10 wherein the virtual cluster comprises one of an Apache Hadoop cluster or an Apache Spark cluster.

12. The apparatus of claim 10 wherein the processing instructions further direct the processing system to:
receive an address request for the virtual cluster from a console device;
identify at least a portion of the port addresses associated with the virtual cluster based on the address request; and
transfer at least the portion of the port addresses associated with the virtual cluster to the console device.

13. The apparatus of claim 12 wherein the processing instructions further direct the processing system to:
identify internet protocol (IP) addresses associated with the one or more hosts; and
transfer the IP addresses to the console device.

14. The apparatus of claim 12 wherein the processing instructions to transfer at least the portion of the port addresses associated with the virtual cluster to the console device direct the processing system to:
generate a display of at least the portion of the port addresses associated with the virtual cluster; and
transfer the display to the console device.

15. The apparatus of claim 10 wherein the virtual nodes comprise Linux containers or Docker containers.

16. The apparatus of claim 10 wherein the one or more hosts comprise one or more virtual machines.

17. The apparatus of claim 10 wherein the one or more hosts comprise one or more physical computing systems.

18. The apparatus of claim 10 wherein the processing instructions to allocate the port addresses to the services in the virtual cluster direct the processing system to configure operating systems on the one or more hosts with the port addresses for the services.
